(19) United States
(12) Patent Application Publication
(10) Pub. No.: US 2015/0043318 A1
(43) Pub. Date: Feb. 12, 2015

(54) READER, AND REPRODUCING APPARATUS AND RECORDING / REPRODUCING APPARATUS

(71) Applicants: PIONEER MICRO TECHNOLOGY CORPORATION, Yamanashi (JP); PIONEER CORPORATION, Kanagawa (JP)

(72) Inventors: Takayuki Kasuya, Kanagawa (JP); Satoshi Sugiura, Kanagawa (JP); Katsumi Yoshizawa, Kanagawa (JP)

(21) Appl. No.: 14/346,476

(22) PCT Filed: Aug. 27, 2012
(86) PCT No.: PCT/JP2012/071592

§ 371 Date: Mar. 21, 2014

(30) Foreign Application Priority Data
Sep. 26, 2011 (JP) 2011-209368

(51) Int. Cl. G11B 5/09

(52) U.S. Cl. CPC G11B 5/09; Y10S 977/951; Y10S 977/947; G11B 2005/0021
USPC 369/13.33; 977/951; 977/947

(57) ABSTRACT

A reader (12) is provided with: a near-field light device (122) having (i) one or a plurality of quantum dots and (ii) an output end (224) laminated on an upper layer of the one or plurality of quantum dot layers; and a light receiving device (124) which is configured to receive light caused by near-field light formed by the near-field light device upon reproduction of record information on a recording medium. According to the reader, the information recorded by heat assisted magnetic recording can be reproduced without providing a separate magnetic circuit.

### TECHNICAL FIELD

The present invention relates to a reader which uses a nano-spot of near-field light such as, for example, heat assisted magnetic recording (HAMR) and scanning near field optical microscope (SNOM), and a reproducing apparatus and a recording/reproducing apparatus which are provided with the reader.

### BACKGROUND ART

As recording/reproducing technology which uses the near-field light, for example, there is proposed a recording apparatus in which a head unit is simplified by connecting a probe for generating the near-field light with a light emitting element and a light receiving element, as a unit, via an optical waveguide (refer to Patent document 1).

Moreover, thanks to recent advances in semiconductor microfabrication technology, nanoscale quantum dots have drawn attention, wherein the nanoscale quantum dots use ultimate particle properties by controlling a single electron with quantum mechanical effects. For example, following technologies are proposed: a production method for appropriately controlling the size of quantum dots (refer to Patent document 2), and a near-field concentrator using multi-layered quantum dots (refer to Patent document 3).

### PRIOR ART DOCUMENT

### Patent Document

Patent document 1: Japanese Patent Application Laid Open No. 2007-317259
Patent document 2: Japanese Patent Application Laid Open No. 2009-231601
Patent document 3: Japanese Patent Application Laid Open No. 2006-080459

### DISCLOSURE OF INVENTION

### Subject to be Solved by the Invention

However, there is such a technical problem that the recording apparatus described in the aforementioned Patent document 1 has low energy utilization efficiency because of the use of the optical waveguide. It is also necessary to separately prepare a magnetic head in order to read magnetic information recorded on a recording medium.

In view of the aforementioned problem, it is therefore an object of the present invention to provide a reader which uses the near-field light, a reproducing apparatus, and a recording/reproducing apparatus which has high energy utilization efficiency.

### Means for Solving the Subject

The above object of the present invention can be solved by a reader is provided with a near-field light device having (i) one or a plurality of quantum dots and (ii) an output end laminated on an upper layer of the one or plurality of quantum dot layers, and a light receiving device which is configured to receive light caused by near-field light formed by the near-field light device upon reproduction of record information on a recording medium.

The above object of the present invention can be solved by a reproducing apparatus is provided with the reader of the present invention, a reproducing device which is configured to reproduce information on the basis of output from the light receiving device, and a controlling device which is configured to control the reader.

The above object of the present invention can be solved by a recording/reproducing apparatus is provided with the reader of the present invention, a reproducing device which is configured to reproduce information on the basis of output from the light receiving device, and a controlling device which is configured to control the reader.

The operation and other advantages of the present invention will become more apparent from an embodiment explained below.

### BRIEF DESCRIPTION OF DRAWINGS

FIG. 1 is a block diagram illustrating a configuration of a recording/reproducing apparatus in an embodiment.

FIG. 2 is a diagram illustrating a structure of a main part of a head in the embodiment.

FIG. 3 are diagrams for explaining the operation of the recording/reproducing apparatus upon recording in the embodiment.

FIG. 4 are diagrams for explaining the operation of the recording/reproducing apparatus upon reproduction in the embodiment.

FIG. 5 are diagrams illustrating one example of an optical guiding member formed in a near-field light device in the embodiment.

FIG. 6 are diagrams illustrating a first modified example of the near-field light device in the embodiment.

FIG. 7 are diagrams illustrating a second modified example of the near-field light device in the embodiment.

FIG. 8 is a diagram for explaining one example of magnetic recording which uses the head in the embodiment.

FIG. 9 is a diagram for explaining another example of the magnetic recording which uses the head in the embodiment.

### MODES FOR CARRYING OUT THE INVENTION

Hereinafter, the embodiment of the recording/reproducing apparatus of the present invention will be explained with reference to the drawings. In each of the drawings below, each layer and each member have different scales so that each layer and each member have sizes large enough to be recognized on the drawing.

(Configuration of Recording/Reproducing Apparatus)

A configuration of the recording/reproducing apparatus in the embodiment will be explained with reference to FIG. 1. FIG. 1 is a block diagram illustrating the configuration of the recording/reproducing apparatus in the embodiment.

In FIG. 1, a recording/reproducing apparatus 100, which is one example of the “recording/reproducing apparatus” and the “reproducing apparatus” of the present invention, is provided with a central processing unit (CPU) 11, a head 12, a position adjuster 13, output adjusters 14 and 15, a signal reader 16, and a rotation adjuster 17.

The head 12 is provided with a magnetic field generator 121, a near-field light device 122, an energy source 123, and a light receiver 124.

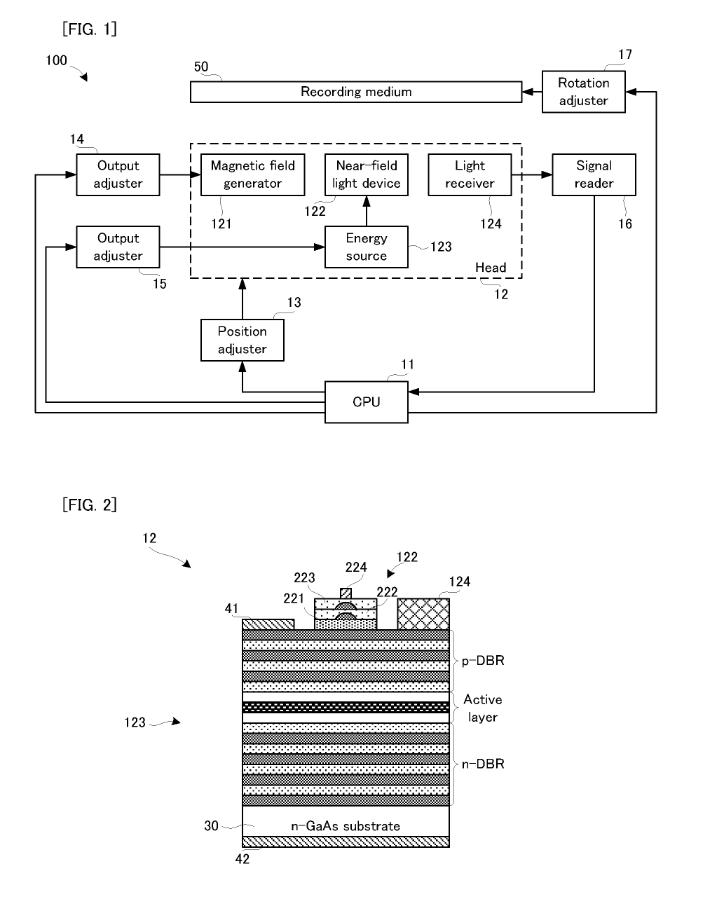

A specific structure of a main part of the head 12 will be explained with reference to FIG. 2. FIG. 2 is a diagram illustrating the structure of the main part of the head in the embodiment. In FIG. 2, a vertical cavity surface emitting laser (VCSEL) is exemplified as a specific example of the energy source 123.

In FIG. 2, the energy source 123 is a VCSEL which is provided with a n-distributed bragg reflector (n-DBR) layer laminated on a n-gallium arsenide (GaAs) substrate 30, an active layer laminated on the n-DBR layer, a p-DBR layer laminated on the active layer, an upper electrode 41 formed on the p-DBR layer, and a lower electrode 42 formed on the back surface of the n-GaAs substrate 30.

The near-field light device 122 is provided with a substrate 211 such as, for example, a GaAs substrate, a quantum dot layer 222 which is laminated on the substrate 211 and which contains, for example, indium arsenide (InAs) quantum dots, a quantum dot layer 223 which is laminated on the quantum dot layer 222 and which contains, for example, InAs quantum dots, and a metal end 224 which is laminated on the quantum dot layer 223.

The metal end 224 may not be made of one type of metal but may have a multilayer structure made of different metals. For example, the metal end 224 may have a two-layer structure in which a gold (Au) layer is formed on a chromium (Cr) layer, or a two-layer structure in which the gold (Au) layer is formed on a titanium (Ti) layer. Moreover, a thin film made of gold (Au) with a thickness of 20 nanometers (nm) to 100 nm may be further formed on the quantum dot layer 223, and the metal end 224 made of gold (Au) may be provided on the gold (Au) thin film. The metal film absorbs energy supplied from the quantum dot layers 222 and 223 which are below the metal film, and the absorbed energy is transferred to the metal end 224. This improves the utilization efficiency of incident energy.

The quantum dots contained in the quantum dot layer 222 receive light emitted from the energy source 123 and generate near-field light. The quantum dots contained in the quantum dot layer 223 receive the energy of the near-field light generated in the quantum dot layer 222 and generate near-field light. The quantum dots contained in the quantum dot layer 223 sometimes receive the light emitted from the energy source 123 and generate near-field light.

The metal end 224 can output to the exterior at least one portion of the energy of the near-field light generated in the quantum dot layer 223. Due to the multilayer quantum dot structure, it is possible to receive higher energy of incident light than a single-layer quantum dot layer and to focus the energy on the metal end 224, more efficiently. For example, the efficiency can be higher in order of three layers, five layers, and eight layers.

In the present invention, the energy of the incident light is transformed in the quantum dot layers 222 and 223, and the energy is focused on the metal end 224. This is different from such a phenomenon that the incident light is transmitted through InAs and GaAs and is directly applied to the metal end 224. By setting the size of the metal end 224 to be several tens nm or less (e.g. 20 nm or less), the energy of the incident light is transformed into the energy of the near-field light with the quantum dots, and the energy is focused on the metal end with a size of several tens nm or less. This is different from such a physical phenomenon that laser light is converged by an objective lens like an existing optical disc.

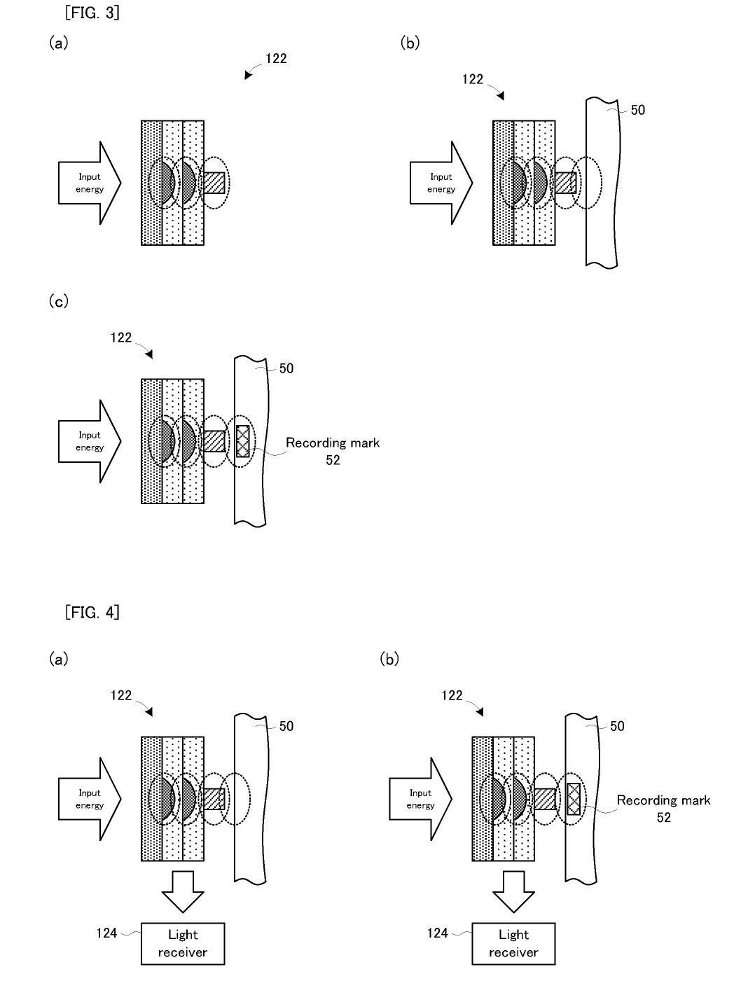

The light receiver 124 receives light caused by the near-field light formed by the near-field light device 122, or by the near-field light device 122 and a recording medium 50. The details will be described (later) with reference to FIG. 3, but the state of the near-field light generated in the near-field light device 122 varies depending on the presence or absence of recording marks formed in the recording medium, or depending on a recording state (the direction of a magnetic field in the case of a magnetic recording medium). This brings high-intensity or low-intensity to the light caused by the near-field light. By detecting the high or low intensity by the light receiver 124, it is possible to read the presence or absence of the recording marks, or a difference in the state.

Here, the “light caused by the near-field light” means light which is not the near-field light such as, for example, scattered light generated by that the near-field light is scattered by some member (i.e. light in a far field).

Incidentally, various known aspects can be applied to the magnetic field generator 121, and thus, the explanation thereof will be omitted in order to avoid a complicated explanation.

Moreover, in order to protect the near-field light device 122, the magnetic field generator 121 and the light receiver 124 on the head 12, a side on which the near-field light device 121 is disposed may be covered with a dielectric substrate such as SiO₂ and may be planarized so that the tip of the metal end 224 appears on a surface of the dielectric substance. By that the side is covered with the dielectric substance or the like, the members disposed on the head can be protected from an impact due to a contact with the recording medium.

Back in FIG. 1 again, the position adjuster 13 is configured to change a positional relation between the head 12 and the recording medium 50. The output adjuster 14 is configured to change the strength of a magnetic field generated by the magnetic field generator 121. The output adjuster 15 is configured to control the output (e.g. light intensity, ON/OFF) of the energy source 123.

The signal reader 16 is configured to generate a reproduction signal on the basis of the output of the light receiver 124. The rotation adjuster 17 is configured to adjust the number of rotations or a rotational speed of the recording medium 50. The CPU 11 integrally controls the position adjuster 13, the output adjusters 14 and 15, and the rotation adjuster 17.

The “CPU11”, the “head 12”, the “signal reader 16”, the “near-field light device 122”, the “light receiver 124” and the “metal end 224” in the embodiment are one example of the “controlling device”, the “reader”, the “reproducing device”, the “near-field light device”, the “light receiving device” and the “output end”, respectively.

(Recording Operation)

The operation of the recording/reproducing apparatus as configured above upon recording will be explained with reference to FIG. 3. FIG. 3 are diagrams for explaining the operation of the recording/reproducing apparatus upon recording in the embodiment. In FIG. 3, a dotted-line circle indicates near-field light.

The recording medium 50 is a magnetic recording medium and may be configured to contain metal such as, for example, gold (Au) in one portion of a layer structure of a magnetic substance or the like which easily interacts with the near-field light generated in the near-field light device 122.

If the energy source 123 is turned ON in accordance with a signal outputted from the output adjuster 15, near-field light is generated at least in a plurality of quantum dots in the quantum dot layers 222 and 223 contained in the near-field light device 122 due to the light (input energy) emitted from the energy source 123. The energy of the near-field light generated in a plurality of quantum dots in the quantum dot layer 222 is focused on the metal end 224 through a plurality of quantum dots in the quantum dot layer 223 to generate near-field light on the metal end 224. If the light emitted from the energy source 123 is applied to the plurality of quantum dots in the quantum dot layer 223, near-field light is generated by the plurality of quantum dots in the quantum dot layer 223, as in the plurality of quantum dots in the quantum dot layer 222. The energy of the near-field light generated by the quantum dots in the quantum dot layer 223 is focused on the metal end 224 to generate near-field light on the metal end 224. In other words, as illustrated in FIG. 3(a), the energy of the light emitted from the energy source is focused on the metal end 224 by the plurality of quantum dots in the quantum dot layers 222 and 223.

If a distance between the metal end 224 and the recording medium 50 is greater than or equal to a predetermined distance (e.g. 20 nm), there is no interaction between the metal end 224 and the recording medium 50, and as illustrated in FIG. 3(a), the near-field light is generated only on the metal end 224.

On the other hand, if the distance between the metal end 224 and the recording medium 50 is less than the predetermined distance, as illustrated in FIG. 3(b), there is the interaction between the metal end 224 and the recording medium 50. The energy of the near-field light generated on the metal end 224 is transferred to the recording medium 50 side, and a region of the recording medium 50 close to the metal end 224 generates heat.

In this case, due to the heat caused by the energy of the near-field light, a heat spot having a higher temperature than the surroundings is formed, and coercive force of one portion of the recording medium 50 in the heat spot is reduced. The CPU 11 controls the magnetic field generator 121 (refer to FIG. 1) via the output adjuster 14 to generate a magnetic field corresponding to information to be recorded, thereby changing the direction of magnetism of the recording medium 50 and performing magnetic recording.

While keeping the situation in which the distance between the metal end 224 and the recording medium 50 is less than the predetermined distance, the CPU controls the energy source 123 via the output adjuster 15 and controls the magnetic field generator 121 via the output adjuster 14 on the basis of record information to be recorded. This makes it possible to continuously record the record information, for example, onto the recording medium 50 which rotates at a constant speed.

Moreover, the recording medium 50 can be not only a magnetic recording medium which uses the magnetic recording, but also a recording medium which uses a phase change material which causes a phase change, a material such as a coloring matter or pigment in which heat causes a chemical change, or various materials in which energy causes non-linear effect.

(Reproduction Operation)

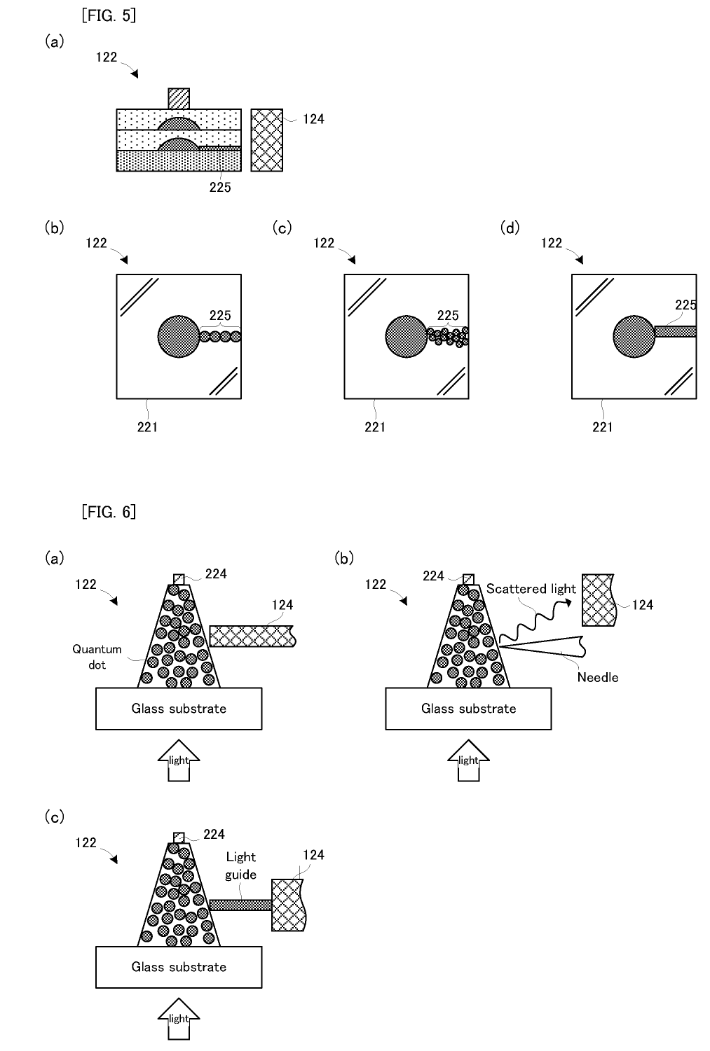

The operation of the recording/reproducing apparatus upon reproduction will be explained with reference to FIG. 4. FIG. 4 are diagrams for explaining the operation of the recording/reproducing apparatus upon reproduction in the embodiment. In FIG. 4, a dotted-line circle indicates near-field light.

If the energy source 123 is turned ON in accordance with the signal outputted from the output adjuster 15 when the distance between the metal end 224 and the recording medium 50 is less than the predetermined distance, the energy of the incident light from the energy source 123 is transformed into near-field light in the quantum dot layers 222 and 223 and is transferred to the metal end 224 to generate near-field light on the metal end 224.

FIG. 4(a) illustrates that there is no recording mark in the vicinity of the metal end 224 in the state in which the distance between the metal end 224 and the recording medium 50 is less than the predetermined distance. FIG. 4(b) illustrates that there is a recording mark in the vicinity of the metal end 224.

When there is no recording mark (FIG. 4(a)), the near-field light generated on the metal end 224 is not influenced by the recording mark. When there is the recording mark (FIG. 4(b)), the near-field light generated on the metal end 224 is near-field light which is influenced by the recording mark. In other words, the presence or absence of the recording mark changes the near-field light generated on the metal end 224. Moreover, the near-field light generated on the metal end 224 which is changed by the presence or absence of the recording mark is propagated to the quantum dots contained in the quantum dot layers 222 and 223 due to the interaction.

The light receiver 124 receives the light caused by the near-field light which is generated on the metal end 224 or the quantum dots of the quantum dot layers 222 and 223 and which changes depending on the presence or absence of the recording mark, and outputs a signal corresponding to the received light. The signal reader 16 generates the reproduction signal on the basis of a signal outputted from the light receiver 124.

Here, according to the study of the present inventors, it is found that if the near-field light or the light caused by the near-field light is received, for example, the presence or absence of a recording mark or the like can be detected, and thus, the information recorded on the recording medium 50 can be read, because the state of the light caused by the near-field light (e.g. polarization, intensity, etc.) also changes.

Incidentally, in the near-field light device 122, as illustrated in FIG. 5, a light guide member 225 for guiding the near-field light to the light receiver 124 is formed. FIG. 5(a) is a diagram illustrating one example of the light guide member formed in the quantum dot layer 222 as the light guide member 225 in the embodiment.

The light guide member 225 may be configured as a set of a plurality of small quantum dots, as illustrated in FIG. 5(b) and FIG. 5(c). Alternatively, as illustrated in FIG. 5(d), the light guide member 225 may be configured as a rectangular island-shaped protrusion. The light guide member 225 may be disposed not only in the quantum dot layer 222 but also in the quantum dot layer 223. Alternatively, the light guide member 225 may be disposed in the vicinity of the metal end 224 to detect a change in the near-field light generated in each portion.

Incidentally, the output of the energy source 123 may be set smaller upon reproduction than upon recording and may be controlled to an energy amount which does not rewrite the recording mark upon reproduction. Upon recording or upon reproduction, the output of the energy source 123 may be set always ON to keep the irradiation, and may be set as a pulse with a predetermined duty ratio.

### First Modified Example

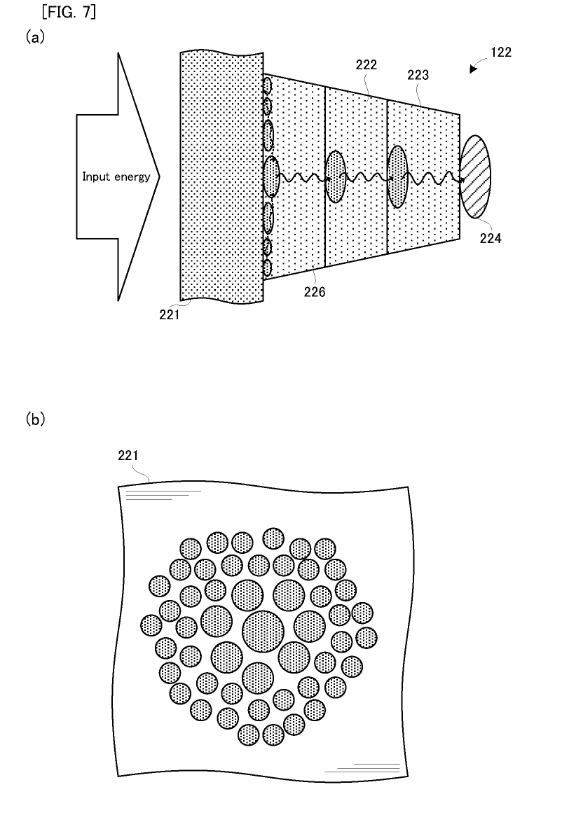

Next, a first modified example of the near-field light device 122 will be explained with reference to FIG. 6. FIG. 6 are diagrams illustrating the first modified example of the near-field light device in the embodiment.

In FIG. 6, the near-field light device 122 is provided with a plurality of quantum dots which are dispersedly distributed in a mesa structure, and a metal end 224 which is laminated on the mesa structure. The mesa structure is configured to gradually become narrower towards an upper layer thereof from a lower layer thereof, and is configured such that the number of the quantum dots also decreases toward the upper layer from the lower layer.

In order to receive the light caused by the near-field light generated in the near-field light device 122 configured as illustrated in FIG. 6, for example, as illustrated in FIG. 6(a), the light receiver 124 may be disposed in the extreme vicinity of the near-field light device 122. Alternatively, as illustrated in FIG. 6(b), the near-field light may be transformed into scattered light by a member such as a needle.

Alternatively, as illustrated in FIG. 6(c), the near-field light may be led to the extreme vicinity of the light receiver 124 by using a light guide.

### Second Modified Example

Next, a second modified example of the near-field light device 122 will be explained with reference to FIG. 7. FIG. 7 are diagrams illustrating the second modified example of the near-field light device in the embodiment. Incidentally, a wavy arrow in the drawings indicates energy propagation.

In FIG. 7, the near-field light device 122 is provided with a substrate 211, a nano fountain layer 226 which is laminated on the substrate 211 and which includes, for example, a plurality of InAs quantum dots, a quantum dot layer 222 which is laminated on the nano fountain layer 226, a quantum dot layer 223 which is laminated on the quantum dot layer 222, and a metal end 224 which is laminated on the quantum dot layer 223.

In the nano fountain layer 226, as illustrated in FIG. 7(b), there are disposed relatively large quantum dots near the center, which are surrounded by a plurality of relatively small quantum dots. FIG. 7(b) is a plan view illustrating the nano fountain layer 226 viewed in a plane on the substrate 211.

By virtue of such a configuration, at least one portion of the energy of near-field light generated in the relatively small quantum dots which receive energy (i.e. input light) inputted from the back surface of the substrate 211 (the left side of FIG. 7) is focused on the relatively large quantum dots which are disposed near the center. Thus, the energy inputted to the near-field light device 122 can be efficiently propagated to the metal end 224, which is extremely useful in practice.

<Magnetic Recording>

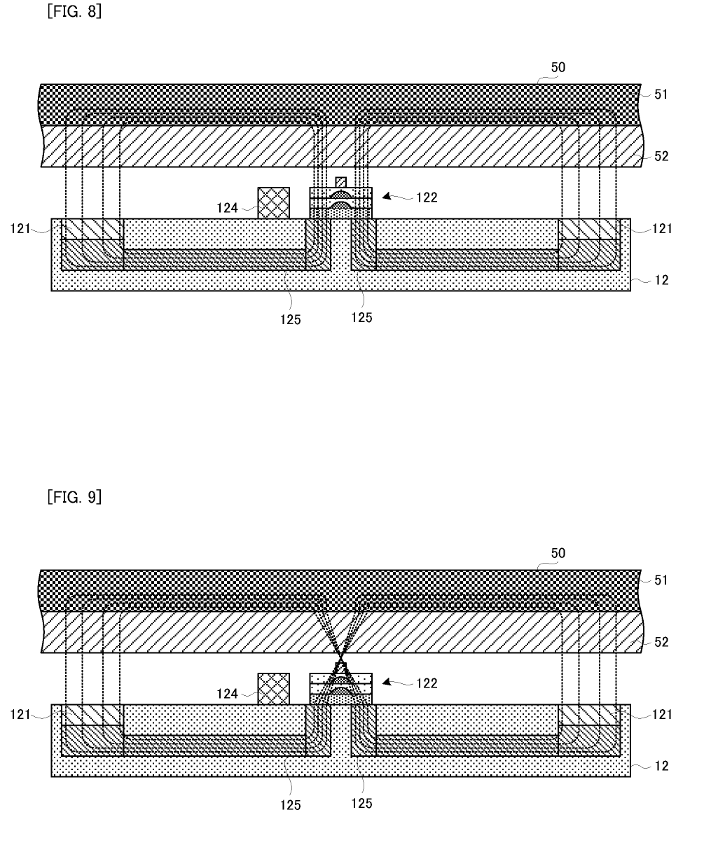

Next, the magnetic recording which uses the head 12 will be explained with reference to FIG. 8 and FIG. 9. FIG. 8 is a diagram for explaining one example of the magnetic recording which uses the head in the embodiment. FIG. 9 is a diagram for explaining another example of the magnetic recording which uses the head in the embodiment. Here, as the recording medium 50, a magnetic recording medium with a recording magnetic layer 52 laminated on a soft magnetic layer 51 is exemplified. In FIG. 8 and FIG. 9, a dotted line indicates a line of magnetic force. Moreover, the illustration of the energy source is omitted.

A representative example of the configuration of the magnetic recording is illustrated in FIG. 8. The magnetic field generated in the magnetic field generator 121 is transferred to below the near-field light device 122 by a magnetic circuit (here, a magnetic waveguide member 125) and is converged through the near-field light device 122. The converged magnetic field passes through the recording magnetic layer 52 of the magnetic recording medium 50 and the soft magnetic layer 51, and returns to the magnetic field generator 121. By this, a closed magnetic circuit is established.

The writing of a recording signal onto the magnetic recording medium 50 is performed by modulation in a magnetic field direction of the near-field light device 122 and/or the magnetic field generator 121, due to an input signal (not illustrated). The writing can be performed not only by the modulation but also by ON/OFF of the magnetic field based on the input signal. The recording may be performed by a combination of the modulation and the ON/OFF of the magnetic field.

Moreover, in recording, the magnetic field is converged to the magnetic recording medium 50 and laser light enters the near-field light device 122 in response to the input signal, and then energy may be applied to a region on which the magnetic flux is focused by the near-field light which is generated in the near-field light device 122 and a partial region of the magnetic recording medium 50 (corresponding to the region on which magnetic flux is forced). Due to the near-field light, holding power of the magnetic recording layer 52 decreases in the region to which the energy is applied. This makes it easy to perform the magnetic recording.

The reading of the recording signal recorded on the magnetic recording medium 50 is performed by monitoring the intensity of the near-field light generated in the surroundings of the near-field light device 122 with the light receiver 124, or by detecting a change in current generated in the magnetic field generator 121 or the like due to the modulation of the magnetic field of the magnetic recording layer 52 according to a recording state (FIG. 8 and FIG. 9 illustrate configuration examples in which the intensity of the near-field light is monitored by the light receiver 124). Of course, it is possible to perform both the monitoring of the intensity of the near-field light with the light receiver 124 and the detection of the change in current generated in the magnetic field generator 121 due to the modulation of the magnetic field of the magnetic recording layer 52, to increase the accuracy of decoding of the recording signal.

FIG. 9 illustrates that the nano particle as the metal end of the near-field light device 122 (i.e. the metal end 224) is made of a magnetic substance such as nickel, iron and cobalt. In comparison with the case of using gold for the nano particle, the concentration of the magnetic field occurs. It is effective to apply the magnetic field in one direction such that the tip fine particle is easily magnetized when the tip fine particle is prepared in a vacuum device or the like.

The tip fine particle of the near-field light device 122 has not only the effect of energy propagation to a micro region of the magnetic recording medium 50 but also the effect of magnetic energy convergence to the micro region of the magnetic recording medium 50. By this, it is unnecessary to provide a reproduction-only magnetic head using TMG and GMR which is conventionally required, and it is possible to perform the extremely high-density writing/reading on the magnetic recording medium 50 by using only one device (the near-field light device 122).

Incidentally, the recording/reproducing apparatus 100 may be provided with a magnetic field reader and a signal reader which is configure to read an output signal of the magnetic field reader, in addition to the near-field light device 122.

The present invention is not limited to the aforementioned embodiments, but various changes may be made, if desired, without departing from the essence or spirit of the invention which can be read from the claims and the entire specification. A reader, and a reproducing apparatus and a recording/reproducing apparatus, which involve such changes, are also intended to be within the technical scope of the present invention.

### DESCRIPTION OF REFERENCE CODES

11 CPU
12 head
13 position adjuster
14, 15 output adjuster
16 signal reader
17 rotation adjuster
50 recording medium
100 recording/reproducing apparatus
121 magnetic field generator
122 near-field light device
123 energy source
124 light receiver
222, 223 quantum dot layer
224 metal end

1. A reader comprising:
a near-field light device having (i) one or a plurality of quantum dots and (ii) an output end laminated on an upper layer of the one or plurality of quantum dot layers;
an energy source supplying the plurality of quantum dots of said near-field light device with energy; and
a light receiving device which is configured to receive light caused by near-field light formed by the near-field light device, which is supplied energy by activated said energy source, upon reproduction of record information on a recording medium.

2. A reproducing apparatus comprising:
the reader according to claim 1;
a reproducing device which is configured to reproduce information on the basis of output from the light receiving device; and
a controlling device which is configured to control the reader.

3. A recording/reproducing apparatus comprising:
the reader according to claim 1;
a reproducing device which is configured to reproduce information on the basis of output from the light receiving device; and
a controlling device which is configured to control the reader.
